(19) United States
(12) Patent Application Publication
(10) Pub. No.: US 2015/0079386 A1
(43) Pub. Date: Mar. 19, 2015

(54) BURN-FREE COLORED GLAZE MATERIAL

(71) Applicant: HANGJINQI YILILANG NEW MATERIAL TECHNOLOGY CO., LTD., Ordos City (CN)

(72) Inventor: Bitao Ma, Guangdong (CN)

(21) Appl. No.: 14/385,760

(22) PCT Filed: Mar. 19, 2013
(86) PCT No.: PCT/CN2013/072876

§ 371 Date: Sep. 16, 2014

(30) Foreign Application Priority Data
Mar. 19, 2012 (CN) 201210085666.2

(51) Int. Cl. C09D 7/12; C08K 3/22

(52) U.S. Cl. CPC C09D 7/1216; C08K 3/22; C08K 2003/2244
USPC 428/328

(57) ABSTRACT

A burn-free colored glaze material, comprising a coloring layer formed by mixing hydroxylated thermoset acrylic acid epoxy resin and nano-sized pigment, and a transparent protective layer disposed outside the coloring layer and comprising hydroxylated thermoset acrylic acid epoxy resin and nano-sized zirconia; the particle diameter of the nano-sized pigment is below 120 nanometers; and the particle diameter of the nano-sized zirconia is below 200 nanometers. The colored glaze product is resistant to sunlight, aging, chemicals, scratching and high temperature, has high strength, and is fire-proof.

### PRIORITY CLAIM

The present application is a National Phase entry of PCT Application No. PCT/CN2013/072876, filed Mar. 19, 2013, which claims priority to Chinese Patent Application No. 201210085666.2, filed Mar. 19, 2012, the disclosures of which are hereby incorporated by reference herein in their entirety.

### TECHNICAL FIELD

The present invention relates to a burn-free colored glaze material, especially to a colored glaze material made by colored glazing process with spraying and free of high temperature burning.

### BACKGROUND ART

If a traditional pottery is needed to be glazed, only by high temperature burning, a cleaning and wear-resistant glaze surface (mirror surface) can be produced onto the pottery. The glaze is a colorless or colored vitreous thin layer coated on the surface of ceramic products; and it is made by grinding mineral raw materials (feldspar, quartz, talc, Kaolin, etc.) and chemical raw materials at a certain proportion (parts of the raw materials can be made into flits previously) into a glaze slurry, applying them onto the body surface, and burning at a certain temperature. It can increase the mechanical strength, thermal stability and the dielectric strength of the products, and also have the characteristics of beautifying utensils, conveniency for wiping, avoiding being eroded by dust and dirt. It should also be achieved by adopting electroplating or other vacuum electroplating methods if metal or other plastic surfaces need to produce a mirror effect. The preparation process of colored glaze materials is complicated, and has a high production cost, high energy consumption, low efficiency, pollution, and is not environmentally friendly.

### SUMMARY OF THE INVENTION

The object of the present invention lies in providing a new colored glaze material, using a spraying method to prepare glaze, which have a low production cost, high efficiency, and is energy-saving, environmentally friendly, and non-toxic. Additionally such colored glaze material can be glazed onto different substrates, and has a wide scope of applicability, large economic benefits, and broad prospects.

In order to achieve the object above, the present invention provides a burn-free colored glaze material, comprising a coloring layer formed by mixing hydroxylated thermoset acrylic acid epoxy resin and nano-sized pigment, and a transparent protective layer disposed outside the coloring layer and comprising hydroxylated thermoset acrylic acid epoxy resin and nano-sized zirconia, wherein the particle diameter of the nano-sized pigment is below 120 nanometers and the particle diameter of the nano-sized zirconia is below 200 nanometers.

The abovementioned burn-free colored glaze material, wherein the particle diameter of the nano-sized pigment is preferably below 100 nanometers, particularly preferably 1-50 nanometers.

The abovementioned burn-free colored glaze material, wherein the weight percentage of the nano-sized pigment in the coloring layer is 1-15%, particularly preferably 3-8%.

The abovementioned burn-free colored glaze material, wherein the particle diameter of the nano-sized zirconia is preferably 50-200 nanometers, particularly preferably 150-200 nanometers.

The abovementioned burn-free colored glaze material, wherein the weight percentage of the nano-sized zirconia in the transparent protective layer is 2-15%, particularly preferably 5-10%.

### BRIEF DESCRIPTION OF THE DRAWING

FIG. 1 is a structural schematic of an embodiment of the colored glaze of the present invention.

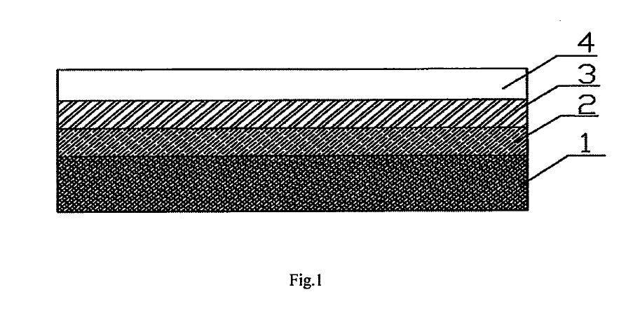

The signs of the accompanying drawing are shown as below:

| | |
|---|---|
| 1- the substrate; | 2- the base layer; |
| 3- the coloring layer; | 4- the transparent protective layer. |

### DETAILED DESCRIPTION

Hereinafter the present invention is further detailedly illustrated in combination with the accompanying drawing: the burn-free colored glaze material of the present invention comprises a coloring layer attached to the substrate, formed by mixing hydroxylated thermoset acrylic acid epoxy resin and nano-sized pigment, wherein the particle diameter of the nano-sized pigment is below 120 nanometers. A transparent protective layer is disposed outside the coloring layer and comprises hydroxylated thermoset acrylic acid epoxy resin and nano-sized zirconia, wherein the particle diameter of the nano-sized zirconia is below 200 nanometers.

The preparation method thereof is as follow: firstly, treating the substrate by washing and degreasing; then spraying adhesive layer by using an air compressor spraying equipment, and baking-curing to a temperature of 60-80° C. for about 5-8 min to enhance the adhesion of the substrate; subsequently, spraying the coloring layer of the present invention by using the air compressor spraying equipment, and baking-curing to a temperature of 110-130° C. for about 10-20 min; finally, spraying the transparent protective layer and baking-curing, wherein the temperature of baking-curing is 140-160° C. with a period of about 16-25 min.

The component ratio below is adopted: the weight percentage of the nano-sized pigment in the coloring layer is 1-15%; the weight percentage of the nano-sized zirconia in the transparent protective layer is 2-15%, and the transparent hydroxylated thermoset acrylic acid epoxy resin accounts for 85-98%. In this condition, colored glaze materials of the following examples 1 to 7 are obtained.

### EXAMPLE 1

The nano-sized pigment was nano Red P.R-254; the particle diameter of the nano-sized pigment in the coloring layer was 90 nanometers; the weight percentage of the nano-sized pigment in the coloring layer was 3%; the particle diameter of the nano-sized zirconia in the transparent protective layer was 190 nanometers; the weight percentage of the nano-sized zirconia in the protective layer was 5%. The colored glaze material prepared according to the above method was treated by the above spraying method, and the test data of the colored glaze obtained were as follows: the surface hardness was greater than or equal to 6H; the weathering resistance and sunlight resistance were grade 8. The test report of SGS heavy metal contents were as follows: cadmium (Cd), plumbum (Pb), hydrargyrum (Hg) and hexavalent chromium (Cr VI) all were N.D. (less than 2 ppm); monobrominated biphenyl, polybrominated biphenyls (PBBs) and polybrominated diphenyl ethers (PBDEs) all were N.D. (less than 5 ppm).

### EXAMPLE 2

The nano-sized pigment was nano Red P.R-254; the particle diameter of the nano-sized pigment in the coloring layer was less than 100 nanometers; the weight percentage of the nano-sized pigment in the coloring layer was 5%; the particle diameter of the nano-sized zirconia in the transparent protective layer was 150-200 nanometers; the weight percentage of the nano-sized zirconia in the protective layer was 5%. The colored glaze material prepared according to the above method was treated by the above spraying method, and the test data of the colored glaze obtained were as follows: the surface hardness was greater than or equal to 6H; the weathering resistance and sunlight resistance were grade 8. The test report of SGS heavy metal contents were as follows: cadmium (Cd), plumbum (Pb), hydrargyrum (Hg) and hexavalent chromium (Cr VI) all were both N.D. (less than 2 ppm); monobrominated biphenyl, polybrominated biphenyls (PBBs) and polybrominated diphenyl ethers (PBDEs) all were N.D. (less than 5 ppm).

### EXAMPLE 3

The nano-sized pigment was nano Red P.R-254; the particle diameter of the nano-sized pigment in the coloring layer was 80-100 nanometers; the weight percentage of the nano-sized pigment in the coloring layer was 8%; the particle diameter of the nano-sized zirconia in the transparent protective layer was 150-200 nanometers; the weight percentage of the nano-sized zirconia in the protective layer was 8%. The colored glaze material prepared according to the above method was treated by the above spraying method, and the test data of the colored glaze obtained were as follows: the surface hardness was greater than or equal to 6H; the weathering resistance and sunlight resistance were grade 8. The test report of SGS heavy metal contents were as follows: cadmium (Cd), plumbum (Pb), hydrargyrum (Hg) and hexavalent chromium (Cr VI) all were N.D. (less than 2 ppm); monobrominated biphenyl, polybrominated biphenyls (PBBs) and polybrominated diphenyl ethers (PBDEs) all were N.D. (less than 5 ppm).

### EXAMPLE 4

The nano-sized pigment was nano Red P.R-254; the particle diameter of the nano-sized pigment in the coloring layer was 40-70 nanometers; the weight percentage of the nano-sized pigment in the coloring layer was 4%; the particle diameter of the nano-sized zirconia in the transparent protective layer was 140-160 nanometers; the weight percentage of the nano-sized zirconia in the protective layer was 10%. The colored glaze material prepared according to the above method was treated by the above spraying method, and the test data of the colored glaze obtained were as follows: the surface hardness was greater than or equal to 6H; the weathering resistance and sunlight resistance were grade 8. The test report of SGS heavy metal contents were as follows: cadmium (Cd), plumbum (Pb), hydrargyrum (Hg) and hexavalent chromium (Cr VI) all were N.D. (less than 2 ppm); monobrominated biphenyl, polybrominated biphenyls (PBBs) and polybrominated diphenyl ethers (PBDEs) all were N.D. (less than 5 ppm).

1. A burn-free colored glaze material, comprising a coloring layer formed by mixing hydroxylated thermoset acrylic acid epoxy resin and nano-sized pigment, and a transparent protective layer disposed outside the coloring layer and comprising hydroxylated thermoset acrylic acid epoxy resin and nano-sized zirconia, which is characterized in that the particle diameter of the nano-sized pigment is below 120 nanometers and the particle diameter of the nano-sized zirconia is below 200 nanometers.

2. The burn-free colored glaze material according to claim 1, which is characterized in that the particle diameter of the nano-sized pigment is below 100 nanometers.

3. The burn-free colored glaze material according to claim 2, which is characterized in that the particle diameter of the nano-sized pigment is 1-50 nanometers.

4. The burn-free colored glaze material according to claim 1, which is characterized in that the weight percentage of the nano-sized pigment in the coloring layer is 1-15%.

5. The burn-free colored glaze material according to claim 4, which is characterized in that the weight percentage of the nano-sized pigment in the coloring layer is 3-8%.

6. The burn-free colored glaze material according to claim 1, which is characterized in that the particle diameter of the nano-sized zirconia is 50-200 nanometers.

7. The burn-free colored glaze material according to claim 6, which is characterized in that the particle diameter of the nano-sized zirconia is 150-200 nanometers.

8. The burn-free colored glaze material according to claim 1, which is characterized in that the weight percentage of the nano-sized zirconia in the transparent protective layer is 2-15%.

9. The burn-free colored glaze material according to claim 8, which is characterized in that the weight percentage of the nano-sized zirconia in the transparent protective layer is 5-10%.
